(19) United States
(12) Patent Application Publication
(10) Pub. No.: US 2005/0050015 A1
(43) Pub. Date: Mar. 3, 2005

(54) Generic iViews

(76) Inventors: Dirk Becker, Reichartshausen (DE); Marko Degenkolb, Wiesloch (DE); Frank Scheerer, Dielhelm (DE); Christian Schloegel, Walldorf (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/652,739

(22) Filed: Aug. 29, 2003

(51) Int. Cl. G06F 17/30

(52) U.S. Cl. 707/3

(57) ABSTRACT

Displaying content from one or more databases includes defining a query by receiving inputs to fields, using the query to retrieve the content from the one or more databases, and integrating the content for display in one of plural generic templates. Integrating the content includes copying one of the plural generic templates and incorporating the content from the one or more databases into a copied generic template.

### TECHNICAL FIELD

This application relates generally to retrieving content from one or more databases and, more particularly, to defining a query that is used to retrieve the content and to customize display of the content.

### BACKGROUND

A database is a collection of information organized so that a computer program can select desired pieces of data. Traditional databases are organized by fields, records, and files. A field is a single piece of information; a record is one complete set of fields; and a file is a collection of records. Another type of database is hypertext based. In a hypertext database, any object, such as a text, image, or video, is linked to any other object in the database.

Applications (i.e., computer programs) exist to retrieve and display information from a database. Limitations on the content that can be retrieved, and the manner in which the information can be displayed, can hinder users. Thus, there exists a need for a way of retrieving and displaying content that can be more precisely tailored to a particular user's needs.

### SUMMARY

In general, in one aspect, the invention is directed to a method of displaying content from one or more databases. The method includes defining a query by receiving inputs to fields, using the query to retrieve the content from the one or more databases, and integrating the content for display in a generic template. By defining a query, and using that query to retrieve content, the invention makes it possible to retrieve, and thereafter display, content that is tailored to a particular user.

This aspect of the invention may also include one or more of the following features.

Defining the query may include receiving an input that specifies an order of presentation and a grouping of the fields in the query. Integrating the content may include displaying the content based on the fields, the order of presentation, and/or the grouping. Integrating the content may also include copying one of plural generic templates, and incorporating the content from the one or more databases into the copied generic template. The fields may include one or more of a first name, a last name, a personnel number, and a date of birth.

The method may include displaying the content using Java Server Pages (“JSP”). The generic template may be a list view template for presenting the content in list form or a tabular view template for presenting the content in tabular form. The method may be performed on a computer system and at least one of the databases may be located on (local to) the computer system. Alternatively, at least one of the databases may be external to (remote from) the computer system. At least one of the databases may include content for a World Wide Web page.

In other aspects, the invention is directed to an apparatus for performing the foregoing method and a machine-readable medium that stores instructions for performing the foregoing method on a machine.

Other features and advantages of the invention will become apparent from the following description, including the claims and drawings.

### DESCRIPTION OF THE DRAWINGS

FIG. 1 is a screen shot of an alert iView.

FIG. 2 is a screen shot of a report iView.

FIG. 3 is a screen shot of an application iView.

FIG. 4 is a screen shot of a text iView.

FIG. 5 is a screen shot of a chart iView.

FIG. 6 is a screen shot of a graphic iView.

FIG. 7 is a screen shot of a dictionary iView.

FIG. 8 is a diagram of an iView tray.

FIG. 9 is a screen shot showing iViews having different formats.

FIG. 10 is a block diagram of a computer network on which the processes described herein may be implemented.

FIG. 11 is a block diagram of a client device and a server on the network of FIG. 10.

FIG. 12 is a process performed by the server of FIG. 10 to generate and display user-defined iViews.

FIGS. 13, 14, 15, 16 and 17 are screen shots showing fields provided in a dialog box for use in defining a query to generate a user-defined iView.

FIG. 18 is a screen shot of a user-defined iView.

Like reference numerals in different figures indicate like elements.

### DESCRIPTION

iView Basics

iViews are self-contained structured documents that may be retrieved via a Uniform Resource Locator (“URL”) presented by a portal. In this context, a portal is a Web site or service that offers a broad array of resources and services, including access to iViews.

iViews integrate content, including information and functions, from different sources into single portal, regardless of the type and location of the source from which such content is retrieved. Content may be retrieved from local or remote databases (including World Wide Web sites), such as Microsoft® Outlook®, Oracle® 11i, WebEx®, mySAP Business Suite®, and Yahoo®.

iViews are stateless, meaning that they are not permanently connected to the underlying computer system. iViews may be viewed in parallel and may provide previews of underlying process data. Iviews can open third-party software, refresh periodically, and allow users to modify their appearance. They also provide users with direct access to information without extensive navigation.

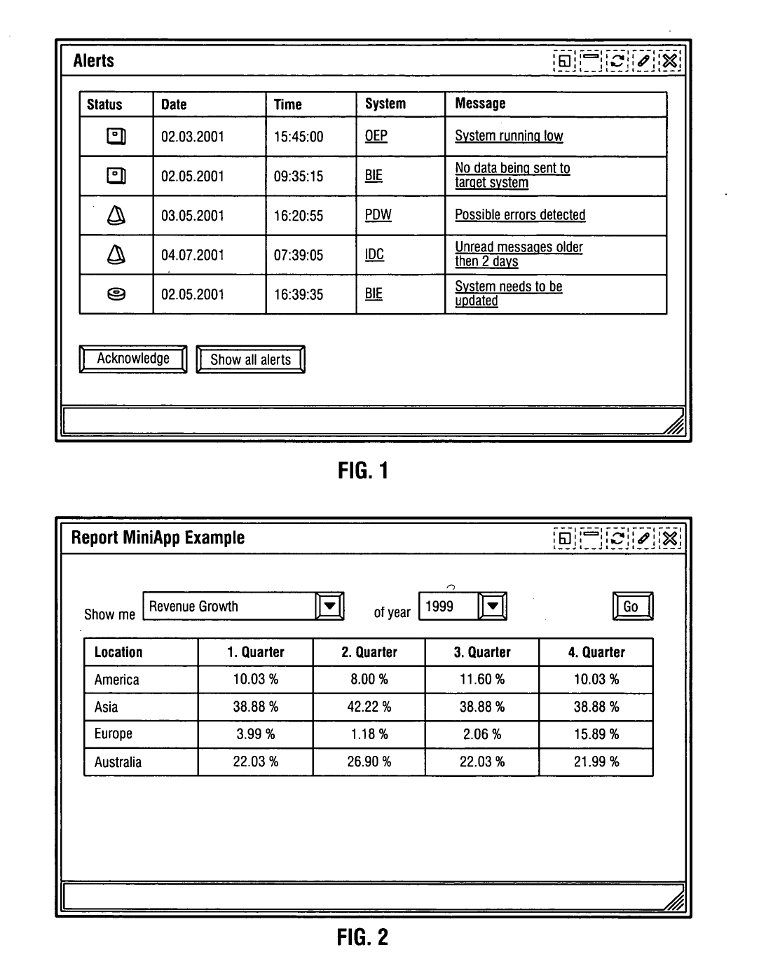

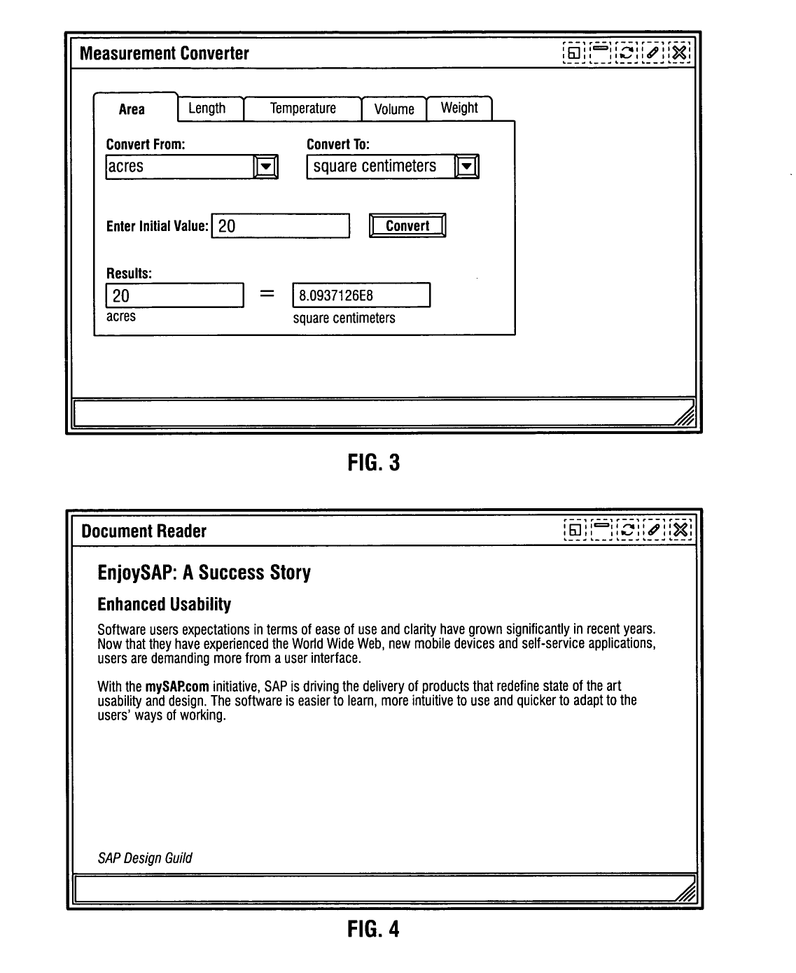

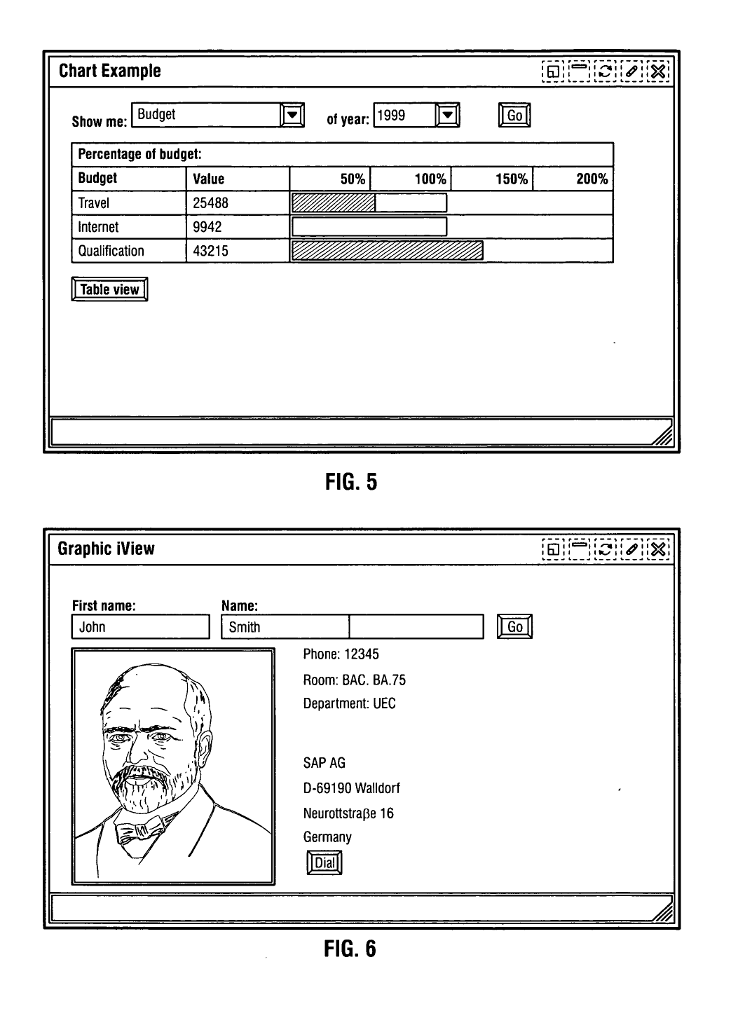

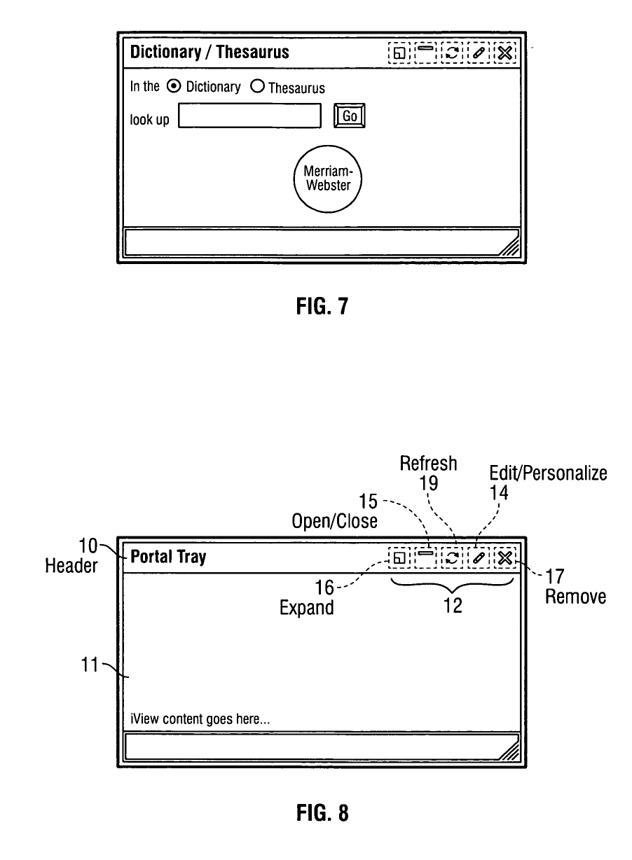

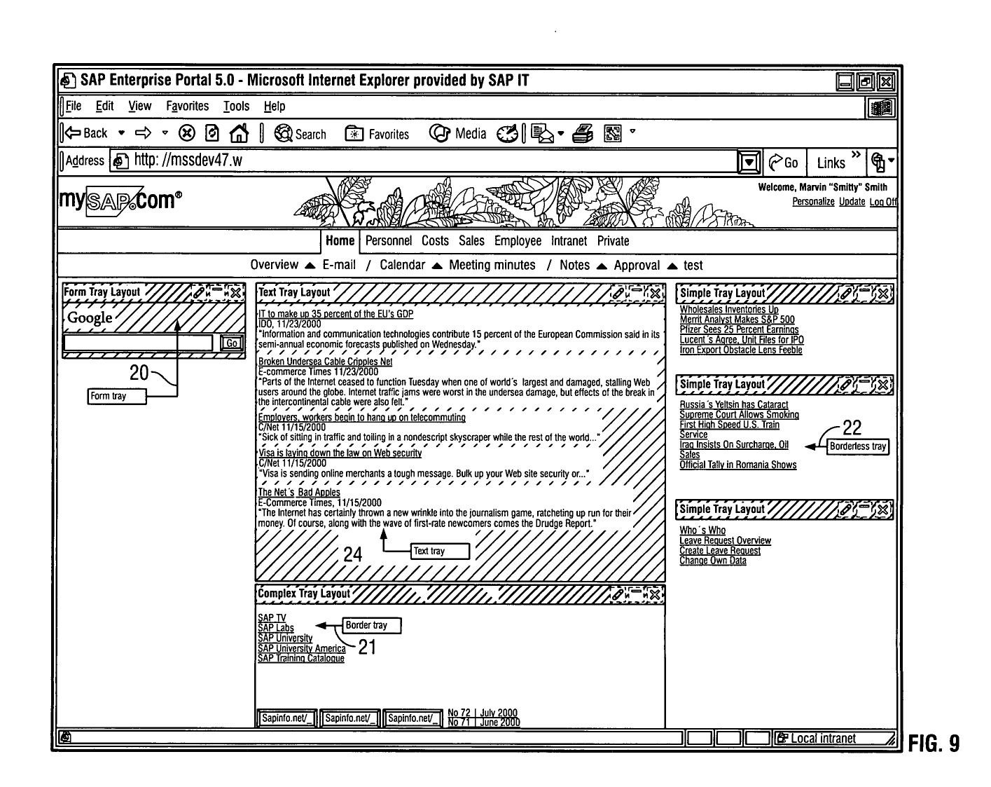

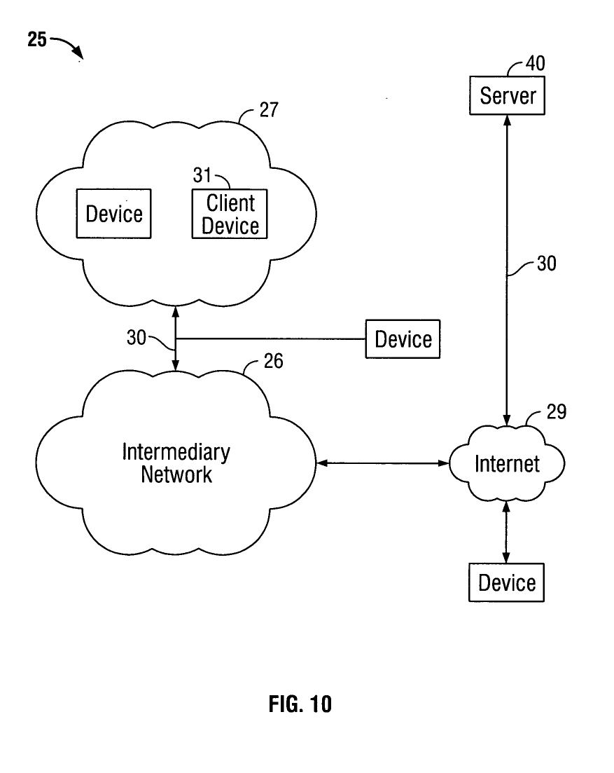

iViews may be predefined to perform a particular function. Examples of predefined iViews include, but are not limited to, the following. An alert iView (FIG. 1) notifies users of critical events. A report iView (FIG. 2) displays a report, typically as a table, or report results, which may also be a table or a chart. An application iView (FIG. 3) is a simple application that enhances a user's working environment. A text iView (FIG. 4) displays text information. A chart iView (FIG. 5) displays data in graphical representations so that characteristics of the data and their relations are understandable. A graphic iView (FIG. 6) displays a graphical image, such as a photograph, a diagram, or a sketch. The graphics may also be animated or video.

While predefined iViews may be tailored to the needs of specific user groups or roles, generic iViews may be defined for individual users. Users can also extend predefined iViews through generic iViews. Generic iViews are described in more detail below.

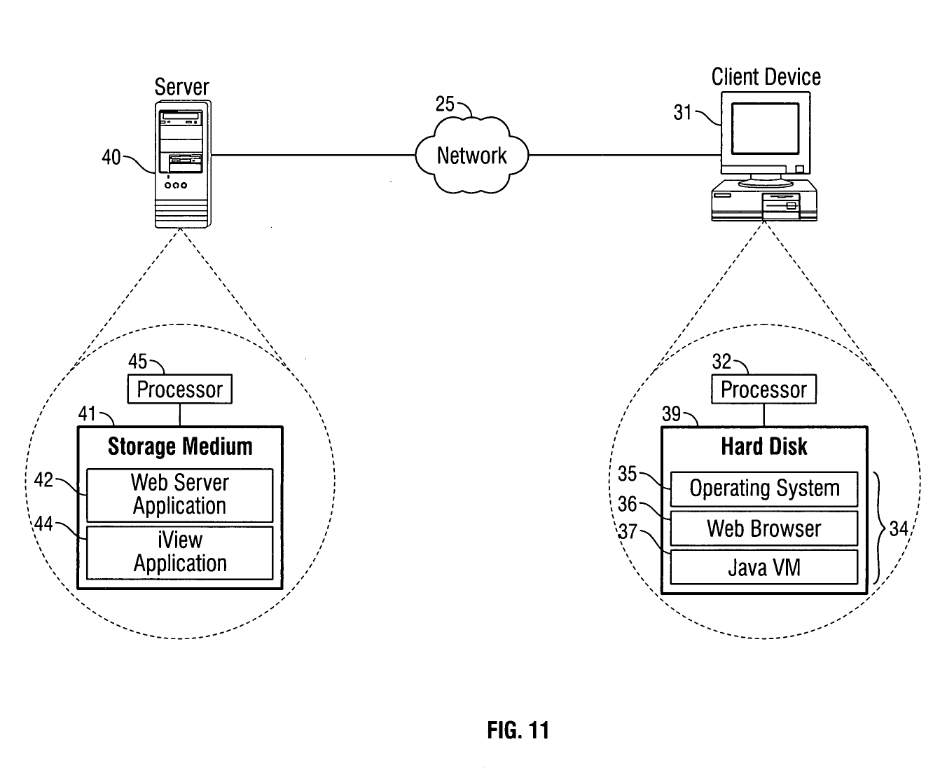

An iView need not be simply a point of entry or an entry mask that provides content from a database, such as a World Wide Web (“Web”) site. An iView may offer additional content to users. Such additional content may be offered as a hyperlink to take a user to a Web site. For example, if a user enters a word in an iView that contains the functionality of a dictionary Web site (see FIG. 7), the definition may appear inside the area of the iView. A link (not shown) to usage examples, similar words, etc. may be provided, which takes the user to the provider's homepage.

iViews on a portal page may be integrated in the sense that they share information or feed one another with information, similar to information “cockpits”. The set of iViews provided in a portal environment is dependent on the role of a user. Iviews can be adapted to a users'role and needs via personalization or customization.

Customization is typically performed by a system administrator for a user role, i.e., for a set of users that fulfill the same role in a company. Customization is used for pre-configuring or setting-up iviews and their appearance on a portal page. Besides specifying the technical and the business background of iviews, customizing can also affect the user interface (e.g., by presetting display attributes) and can be used to specify the extent of personalization a user is allowed to do.

Personalization is performed by individual users to adapt iViews to the users'personal needs. In its simplest form, users can decide, for a predefined set of iviews (predefined according to their role), whether and where they want to display an iView on a portal page. User settings may relate to a set of display options (such as “display status bar”) or per-application settings (such as “refresh-cycle”). They can also affect the interface itself and the data to be displayed.

Typically, the selection of iViews to display in a portal page is performed using tools provided with the portal environment. Personalization of the iViews themselves is handled via a dialog window.

iViews reside in the content area or work space of a portal page. Portal pages that host iViews may be collapsible and expandable. Thus, users may hide less important, or currently not used, iViews and show them again as needed. Vertical scrolling within a portal page allows users to quickly position on an iView without the need for closing other iViews. This type of navigation is efficient for, and suited to, Web browsers, since users can switch between iViews without experiencing page reloads.

Generally speaking, an iView is comprised of two parts: a software (“iView”) application and a framework (or container) that encapsulates the application. The iView application is JAVA-based and is responsible for retrieving content from databases specified in queries in a definition of the iView, and for displaying content retrieved via those queries. An element, called a “tray”, serves as a container for iViews. While the application implements most of the functionality of the iView experienced by the user, the tray delivers interfaces to common functions used by iViews. These functions include a hide/show mechanism and the ability to personalize an iView. The tray is thus responsible for displaying standard user interface elements and the application delivers the content via the standardized interfaces.

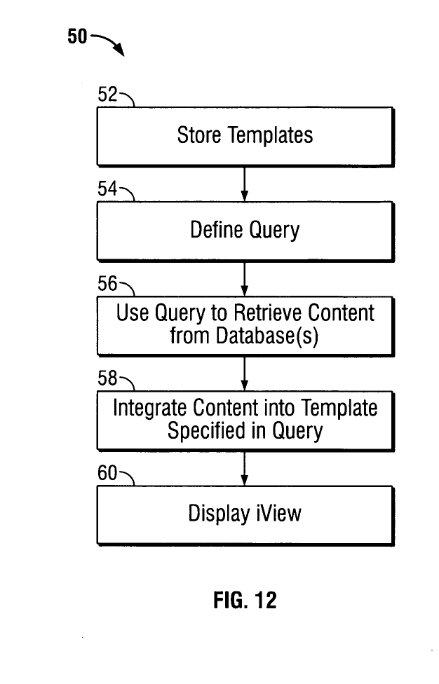

The tray is part of the portal framework. The tray includes a header bar 10 and a content area 11 (see FIG. 8). A status area may also be included. Header bar 10 contains the iView title (not shown) and icons 12 for accessing standard tray functionality. Trays may be available in different designs (see below). The different designs may be distinguished by the color of the content area, and by whether the content area has a border.

The tray provides the following functions: expand, open/close, refresh, edit, and remove. Edit icon 14 opens a dialog or personalize page that allows users to change characteristics of an iView according to their needs. The tray also has a toggle button 15 that allows users to open (collapse) and close (restore) an iView. An open iView's header shows the close icon. When the button is pressed, the iView is reduced to its header, and the toggle button shows the open icon. Expand icon 16 opens an iView in a new window. The original copy remains on the portal page. Remove icon 17 removes the iView from the portal page. Refresh icon 19 refreshes an iView. Depending on its functionality, a simple browser refresh or a more complex refresh handled by the application may be carried out.

Some iViews will contain data that changes over time. Examples of such data include stock quotes and “inbox” items. Depending on the character of the iView, knowing exactly how old or recent displayed information is can be crucial to overall usability of an application. Besides knowing about the “age” of a piece of information, in some cases, it may be necessary to update the content of an iView. The intervals for the updating or “refresh” procedure can vary from once a day to every minute, from automatic to manual refresh. The iView provides an option enabling a user to personalize this setting. The application may perform the updates, as necessary.

As noted above, there are four tray types available: the form tray (for hosting forms), the border tray (for complex content), the borderless tray (a relatively simple tray), and a text tray (for text). These tray types differ from each other in terms of header bar color, background color, and border color. The same types of functionality may be provided across all tray types.

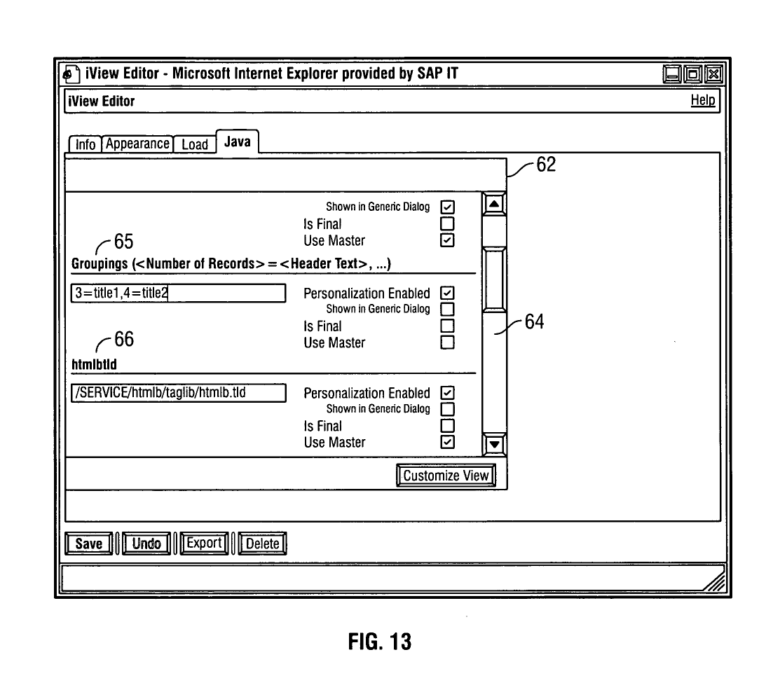

Each of the trays comes with a name referring to its proposed content. Form tray 20 (FIG. 9) has a colored header bar, no outside border, and a light colored background color for the content. It is used when an iView's content includes form elements, such as an entry field, a dropdown list box, checkboxes, or radio buttons. White input fields can be clearly distinguished from the slightly colored background of this tray type. Grouping of the elements sets them apart from the colored background.

Border tray 21 has a colored header bar, an outside border, and no background color for the content. A collection of different elements may not be recognizable as a group. A border tray may be used to group such elements.

Borderless tray 22 is the simplest tray type. The borderless tray has a colored header bar, no outside border, and no background color for the content. This tray is used for clearly shaped elements, e.g., linked lists, that do not need an additional frame for grouping.

Text tray 24 has a light colored header bar, no outside border, and a light colored background for the content (the same color as the header bar when the iView is in the open state). The slightly colored background makes text easier to read than a pure white background. This tray type is well suited to accommodate large amounts of text, as the text appears in news or articles.

Hardware And Software

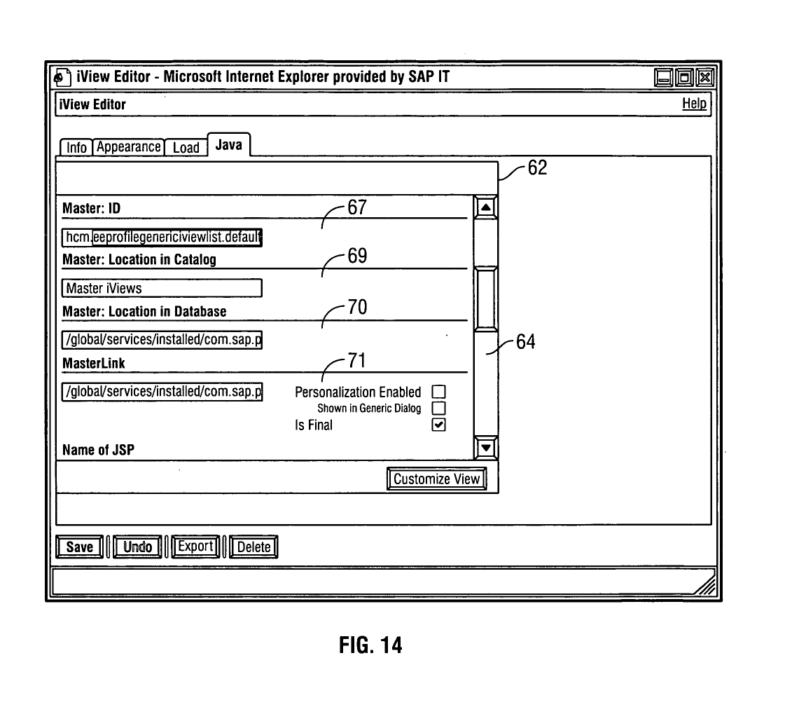

FIG. 10 shows an example of a network 25 that may be used to access and view iViews. Network 25 is described here to illustrate one possible network that may be used to access and view iViews (generic iViews in particular). It is noted, however, that iViews may be accessed on any type of network, which may or may not include the functionality, elements, and/or devices of network 25.

Network 25 may include a number of networks (e.g., intermediary network 26, intranet 27, and Internet 29) to enable communications between one or more devices on network 25. Via communications paths 30, devices on network 25 may connect directly via intermediary network 26, or connect indirectly via intranet 27 or Internet 29.

Intermediary network 26 and intranet 27 (as well as Internet 29) may be implemented using any number of components and/or network devices (e.g., hubs, routers, switches, servers, repeaters, storage devices, communications interfaces, processors, and various communications media) to establish a local area network (LAN), a wide area network (WAN), a switched network, a radio network, a cable network, a satellite network, or a combination of one more of these types of networks.

Intermediary network 26, intranet 27, and Internet 29 may include one or more host devices, such as, for example, servers to provide access to the network, to online services, and to internal and/or external databases. Devices on network 25 may be operated by one or more users to communicate with each other.

An example of a client device 31 on network 25 is a general-purpose computer capable of responding to and executing stored instructions. Other examples of client devices include, but are not limited to, a special-purpose computer, a personal computer (“PC”), a workstation, a server, a laptop, a Web-enabled telephone, a Web-enabled personal digital assistant (“PDA”), an interactive television set, a set top box, an on-board (i.e., vehicle-mounted) computer, or a combination of one or more these devices that is/are capable of responding to, generating, and/or executing instructions. Devices on network 25 may incorporate any number of other devices, components, and/or peripherals, such as memory/storage devices, input devices, output devices, user interfaces, and/or interfaces.

Communications paths 30 may be configured to send and receive signals (e.g., electrical, electromagnetic, and/or optical) that convey or carry data streams representing various types of analog and/or digital content. Communications paths 30 may be implemented using various communications media and one or more networks comprising one or more network devices (e.g., servers, routers, switches, hubs, repeaters, and storage devices). The one or more networks may include a WAN, a LAN, a plain old telephone service (“POTS”) line network, a broadband network, a digital subscriber line (“DSL”) network, an integrated services digital network (“ISDN”), and a synchronous optical network (“SONNET”), or a combination of one or more of these networks. Communications paths 30 may include one or more wireless links that transmit and receive electromagnetic signals, such as, radio, infrared, and microwave signals to convey information.

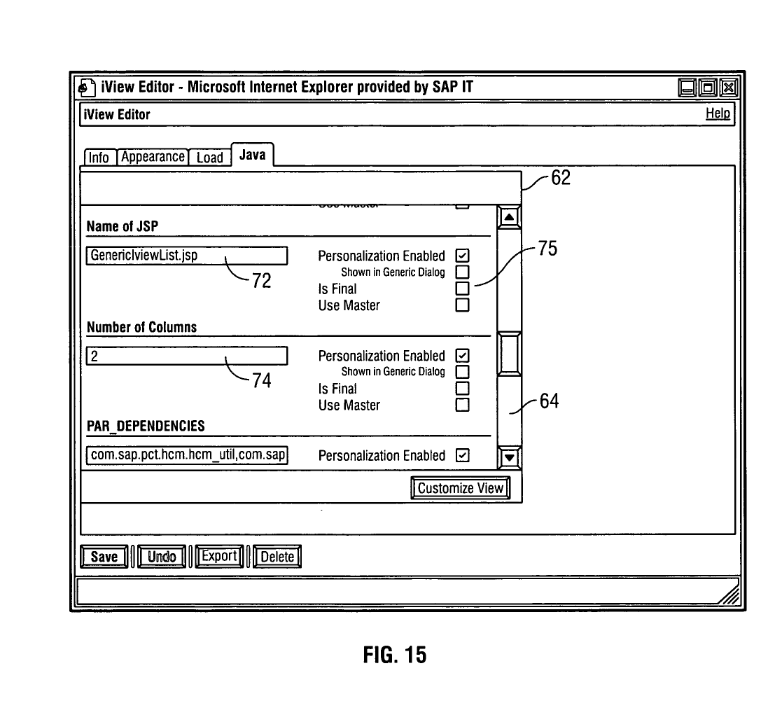

As shown in FIG. 11, client device 31 may include a processor 32 to execute one or more applications 34, such as an operating system 35, a Web browser 36, and JAVA virtual machine 37 (which are stored in memory, e.g., hard disk, 39). These applications allow client device 31 to access Web sites or other databases via network 25.

A server 40 on network 25 hosts a Web site that provides client device 31 with access to iViews. Referring to FIG. 11, server 40 executes Web server application 42 and iView application 44 (which may, or may not, be part of Web server application 42). iView application 44 generates iViews for display and Web server application 42 provides the resulting iViews to client device 31 via network 25. Web server application 42 and iView application 44 may comprise computer programs, piece(s) of code, instruction(s), or some combination thereof, for independently or collectively instructing server 40 to interact or operate to perform the appropriate functions.

Web server application 42 and iView application 44 may be embodied permanently or temporarily in any type of machine, component, physical or virtual equipment, storage medium, or propagated signal or wave capable of providing instructions to server 40. In particular, the applications may be stored on a storage medium 41 (e.g., read only memory (ROM), a random access memory (RAM), a volatile/non-volatile memory, a magnetic disk, or a propagated signal) that is readable by a processor 45 (in server 40), which executes instructions in the applications.

Generic iViews

Generic iViews functionality is embedded in iViews application 44. Generic iViews functionality enables a user to create custom iViews. What is meant by “custom iView”, in this context, is an iView that contains information that is tailored to a particular user. This is in contrast to the predefined iViews described above, which display the same general iView for a specified group.

By way of example, a user may want an iView that retrieves and displays, from a one database, “organizational assignment” information for a specified employee, such as the identity of an organizational unit to which the employee belongs and a geographic location of the employee. The user may also want to retrieve and display, in the same iView, “office contact” information for the employee, such as the employee's electronic mail address, telephone number, and facsimile number. The “office contact” information may be retrieved from a different database than the “organizational assignment” information.

To retrieve the foregoing content, a functional module in iView application 44 defines an advanced business application programming (“ABAP”) query. An iView editor permits the user to define the query by allowing the user to specify desired fields (e.g., personnel number, first name, last name, date of birth, etc. for the specified employee), to set an order for presentation of retrieved data, and to group fields of the query for presentation.

iView application 44 retrieves the content specified in the user-defined query. To display the content retrieved via the query, iView application 44 makes a copy of a predefined generic iView template and displays the retrieved content in the template. This process is described in more detail below.

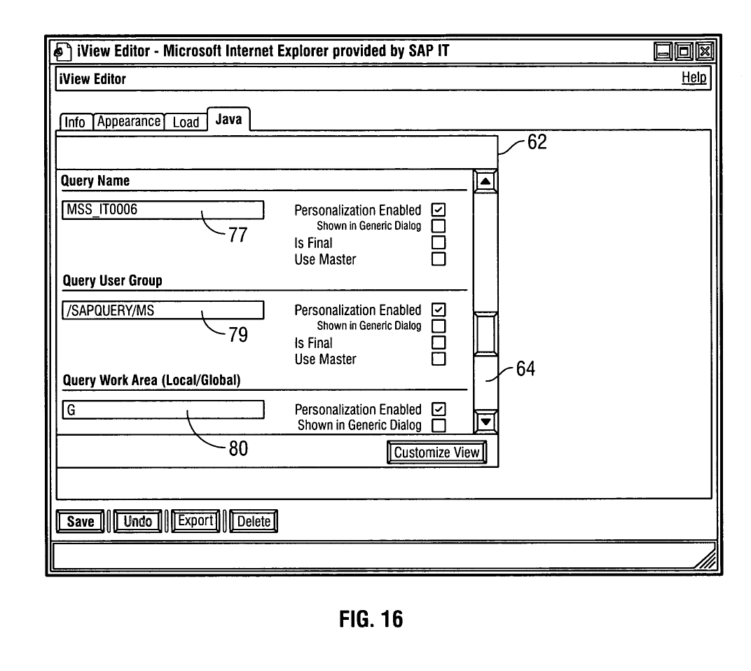

FIG. 12 shows a process 50 to generate and display custom iViews. Process 50 may be performed by any computer to retrieve and display content stored on any database(s). For example, process 50 may be performed by iView application 44 (running on server 40) to retrieve and display content from databases on, e.g., intermediary network 26 and/or Internet 29. In another example, process 50 may be performed by iView application 44 to retrieve content only from databases local to server 40.

Process 50 stores (52) generic templates (called “master iViews”). The generic templates may be stored in memory anywhere on network 25, and allow different properties to be defined within an iView. In this embodiment, two types of generic templates are used: a list view template and a tabular view template.

The list view template displays iView content in list format, e.g., by listing the content. The tabular view template displays iView content in tabular format, e.g., by creating tables to contain the content.

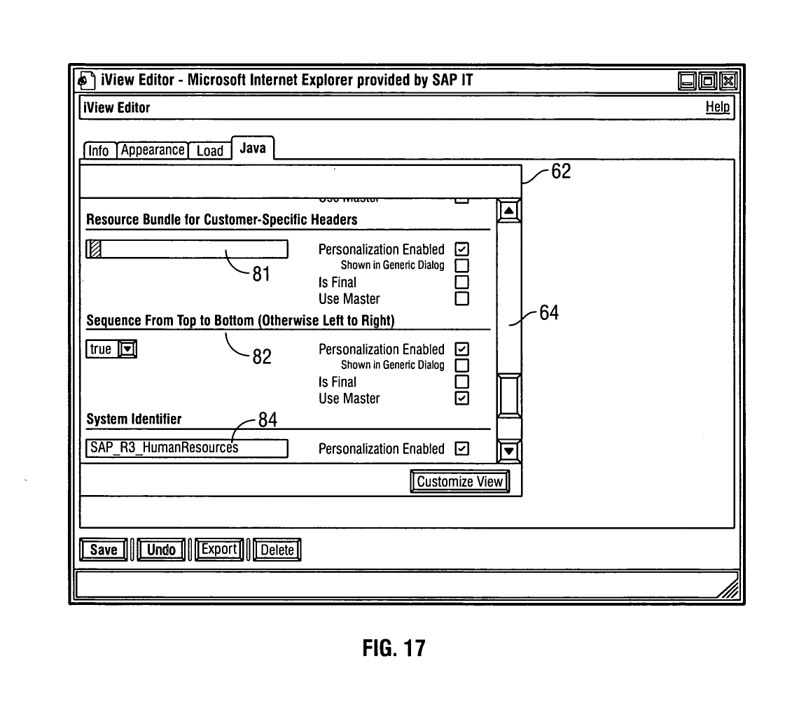

Process 50 defines (54) a query for use in retrieving content from one or more databases. The query may be defined using an iView editor, which may be generated by iView application 44. The iView editor is a windows-based application that generates dialog box 62 shown in FIGS. 13 to 17. Only one dialog box is shown in the five figures. A scroll bar 64 allows a user to scroll down through dialog box 62 in order to view the fields shown in the figures.

Via these fields, a user can provide inputs to define a query. By way of example, in the fields of FIG. 13, a user can select groupings 65 to display content via an iView. The user can also specify a location 66 of an “htmlbtld” library used to generate the iViews. The htmlbtld library provides visible and invisible hypertext markup language (“HTML”) controls that enable iView application 44 to generate iViews for retrieved content.

In the fields of FIG. 14, the user can specify a master iView (e.g., a list view template or a tabular view template). In particular, the user may specify an identity (“ID”) 67 of the master iView, a location 69 of the master iView in an electronic catalog, a location 70 of the master iView in a database, and a link 71 to the master iView.

In the fields of FIG. 15, a user can specify the name 72 of Java Server Pages (“JSP”) that can be used to represent data lists retrieved via the query. In this regard, JSPs are used to represent data lists for the list view template. (The fields shown in FIGS. 13 to 17 are configured to specify a list view template. In the case of a tabular view template, iView application 44 makes use of any available portal data viewer resident on client device 31 to represent data lists retrieved via the query.) The user can also specify, in dialog box 62, a number of columns 74 used to list data retrieved via the query. Check boxes 75, which appear to the right of the various fields, indicate whether “personalization” has been enabled for that field, as well as other options.

In the fields of FIG. 16, a user can specify a name 77 of the query, a user group 79 for the query, and a work area 80 (e.g., global or local) for the query. In this regard, in order to fully identify the query in this embodiment, these three parameters (work area, user group, and query name) should be defined by the user. In other embodiments, this need not be the case.

In the fields of FIG. 17, the user can specify a resource bundle 81 for specific iView headers, an order 82 in which data is to be displayed (i.e., sequenced or presented), and a system identifier 84. The system identifier identifies the computer system (i.e., database(s)) to which the query is directed.

Other information (not shown) may also be used to define the query. For example, in a human resources context, the other information may include a first name, a last name, a personnel number, and a date of birth of an employee about whom content is being retrieved.

Typically, in a human resources database, such information is stored in “infotype” (i.e., information types) records. Separate infotypes may include, e.g., organizational data, address data, pay information, and tax information for an employee. Infotype records may have an assigned validity range and may have temporal limitations (e.g., organizational data can only exist once per employee at a point in time, whereas multiple dependents can be stored at any point in time). Thus, it may be appropriate to present organizational data in list form, while “dependents” data may best be presented in tabular form.

Referring back to FIG. 12, once a query is defined (54), process 50 uses (56) the query to retrieve content from database(s) specified in the query. In the example shown in FIGS. 13 to 17, process 50 may retrieve data from the SAP₁₃ R3_HumanResources database (system identifier 84, FIG. 17). This database may be local to server 40 (on which iView application 44 is running) or remote vis-à-vis server 40. It is also noted that process 50 may retrieve data from more than one database, as necessary.

Process 50 generates a user-customized iView using content retrieved via the query. To this end, process 50 integrates (58) the content retrieved via the query for display in the master iView (generic template), which is also defined in the query. In particular, process 50 copies the appropriate master iView from the location specified in the query to a local location and incorporates the retrieved content into the master iView. When incorporating the retrieved content into the master iView, process 50 arranges the content according to the fields specified in the query (e.g., order of presentation, number of columns, and other such information).

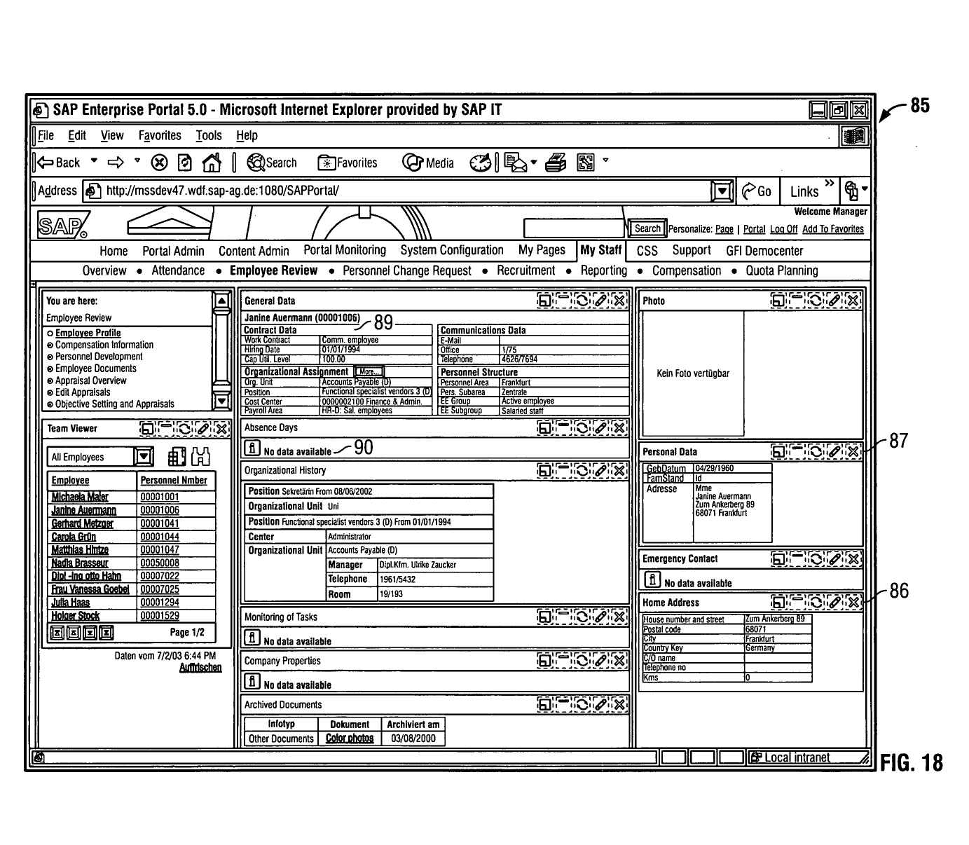

Process 50 displays (60) the iView in an appropriate tray on a portal shown on client device 31. An example of an iView 85 generated according to process 50 is shown in FIG. 18. iView 85 relates to an employee and includes information obtained from a human resources database. The information includes, e.g., an address 86 of the employee, personal data 87 for the employee, contract data 89 for the employee, absence days 90 (a field is shown here, but no data has been provided), and so on.

### OTHER EMBODIMENTS

The processes described herein for generating and displaying iViews, such as process 50 of FIG. 12, may find applicability in any computing or processing environment.

These processes may be implemented using software, hardware (including circuitry such as a processor, logic gates, and/or programmable logic), or a combination thereof.

The processes for generating and displaying iViews may be implemented using one or more computer programs executing on one or more programmable computers or other machines that each includes a processor and a storage medium that is readable by the processor.

Each such program may be implemented in a high-level procedural or object-oriented programming language to communicate with a computer system. However, the programs can be implemented in assembly or machine language. The language may be a compiled or an interpreted language.

Each computer program may be stored on a storage medium or other article of manufacture (e.g., CD-ROM, hard disk, or magnetic diskette) that is readable by a general or special purpose programmable computer for configuring and operating the computer when the storage medium or device is read by the computer to execute the processes described herein for generating and displaying iViews. These processes may also be implemented as one or more machine-readable storage media, configured with one or more computer program(s), where, upon execution, instructions in the computer program(s) cause one or more machines to operate to generate and display iViews.

The invention is not limited to the embodiments described herein. For example, the queries described above for use in creating custom iViews are not limited to the fields specified above. Other fields may be used. Use of iViews is not limited to the human resources context or to any context for that matter. The invention is not limited to use with the generic templates described herein, namely the list view template and the tabular view template. Other types of generic templates may be used. The invention may be used with any type of database.

The invention has been described in the context of a particular structured document, namely the iView, which is provided by SAP AG of Walldorf, Germany. However, the concepts described herein are applicable to any type of structured document that may be generated and displayed using data retrieved from one or more databases.

The functionality of client device 31 and server 40 may be implemented on a single machine, or distributed among more than two machines.

One or more blocks shown in the flowchart of FIG. 12 may be rearranged, substituted, or omitted. As such, operations performed by the process are not limited to the flow pattern shown in the flowchart.

Other embodiments not described herein are also within the scope of the following claims.

1. A method of displaying content from one or more databases, the method comprising:
defining a query by receiving inputs to fields;
using the query to retrieve the content from the one or more databases; and
integrating the content for display in a generic template.

2. The method of claim 1, wherein defining the query comprises receiving an input specifying an order of presentation and a grouping of the fields.

3. The method of claim 2, wherein integrating the content comprises displaying the content based on the fields, the order of presentation, and the grouping.

4. The method of claim 1, wherein the fields comprise one or more of a first name, a last name, a personnel number, and a date of birth.

5. The method of claim 1, wherein integrating the content comprises:
copying the generic template; and
incorporating the content from the one or more databases into the copied generic template.

6. The method of claim 1, further comprising displaying the content using Java Server Pages.

7. The method of claim 1, wherein the generic template comprises one of a list view template for presenting the content in list form and a tabular view template for presenting the content in tabular form.

8. The method of claim 1, wherein the method is performed on a computer system and at least one of the databases is located on the computer system.

9. The method of claim 1, wherein the method is performed on a computer system and at least one of the databases is external to the computer system.

10. The method of claim 1, wherein at least one of the databases comprises content for a World Wide Web page.

11. A machine-readable medium that stores instructions for use in displaying content from one or more databases, the instructions causing a machine to:
define a query by receiving inputs to fields;
use the query to retrieve the content from the one or more databases; and
integrate the content for display in a generic template.

12. The machine-readable medium of claim 11, wherein defining the query comprises receiving an input specifying an order of presentation and a grouping of the fields.

13. The machine-readable medium of claim 12, wherein integrating the content comprises displaying the content based on the fields, the order of presentation, and the grouping.

14. The machine-readable medium of claim 11, wherein the fields comprise one or more of a first name, a last name, a personnel number, and a date of birth.

15. The machine-readable medium of claim 11, wherein integrating the content comprises:
copying the generic template; and
incorporating the content from the one or more databases into the copied generic template.

16. The machine-readable medium of claim 11, further comprising instructions to display the content using Java Server Pages.

17. The machine-readable medium of claim 11, wherein the generic template comprises one of a list view template for presenting the content in list form and a tabular view template for presenting the content in tabular form.

18. The machine-readable medium of claim 11, wherein at least one of the databases is located on a same computer system as the machine-readable medium.

19. The machine-readable medium of claim 11, wherein at least one of the databases is external to a computer system that contains the machine-readable medium.

20. The machine-readable medium of claim 11, wherein at least one of the databases comprises content for a World Wide Web page.

21. An apparatus for displaying content from one or more databases, apparatus comprising:
circuitry to:
define a query by receiving inputs to fields;
use the query to retrieve the content from the one or more databases; and
integrate the content for display a generic template.

22. The apparatus of claim 21, wherein defining the query comprises receiving an input specifying an order of presentation and a grouping of the fields.

23. The apparatus of claim 22, wherein integrating the content comprises displaying the content based on the fields, the order of presentation, and the grouping.

24. The apparatus of claim 21, wherein the fields comprise one or more of a first name, a last name, a personnel number, and a date of birth.

25. The apparatus of claim 21, wherein integrating the content comprises:
copying one of the plural generic templates; and
incorporating the content from the one or more databases into the copied generic template.

26. The apparatus of claim 21, wherein the circuitry displays the content using Java Server Pages.

27. The apparatus of claim 21, wherein the generic template comprises a list view template for presenting the content in list form and a tabular view template for presenting the content in tabular form.

28. The apparatus of claim 21, wherein at least one of the databases is located on the apparatus.

29. The apparatus of claim 21, wherein at least one of the databases is external the apparatus.

30. The apparatus of claim 21, wherein at least one of the databases comprises content for a World Wide Web page.

31. The method of claim 1, wherein integrating comprises integrating the content for display in one of plural generic templates.

32. The machine-readable medium of claim 11, wherein integrating comprises integrating the content for display in one of plural generic templates.

33. The apparatus of claim 21, wherein integrating comprises integrating the content for display in one of plural generic templates.
